(19) United States
(12) Patent Application Publication
(10) Pub. No.: US 2016/0245238 A1
(43) Pub. Date: Aug. 25, 2016

(54) CANISTER, AND CANISTER VENT SOLENOID VALVE

(71) Applicant: MITSUBISHI ELECTRIC CORPORATION, Tokyo (JP)

(72) Inventor: Masatoshi UEDA, Tokyo (JP)

(73) Assignee: MITSUBISHI ELECTRIC CORPORATION, Tokyo (JP)

(21) Appl. No.: 15/031,801

(22) PCT Filed: Jan. 9, 2014
(86) PCT No.: PCT/JP2014/050210

§ 371 Date: Apr. 25, 2016

(51) Int. Cl. F02M 25/08

(52) U.S. Cl. CPC F02M 25/0836; F02M 25/0854; F02M 2025/0845

(57) ABSTRACT

A leak diagnosis is performed on an evaporated fuel processing piping system 5 by inserting a canister vent solenoid valve 6 into an insertion port 303 of a canister 2 and inserting an air pump 7 into an insertion port 305 of the canister 2. When it is configured that the canister vent solenoid valve 6 and the air pump 7 can be inserted separately into the canister 2 in this manner, a system for diagnosing a leak in the evaporated fuel processing piping system 5 can be installed in a more saved space than a case where a module integrating the canister vent solenoid valve 6 and the air pump 7 is inserted thereinto. Moreover, a configuration corresponding to an employed leak diagnosis method can be realized without changing the canister 2.

### TECHNICAL FIELD

The present invention relates to a structure for inserting into a canister a canister vent solenoid valve and an air pump to be employed in diagnosing a leak by using pressure variation in automobile piping, and also relates to the canister and the canister vent solenoid valve.

### BACKGROUND ART

In a popular method of diagnosing a leak in an evaporated fuel processing piping system disposed in an automobile, the leak in the evaporated fuel processing piping system is diagnosed by monitoring pressure variations occurring when a pressure is applied to the inside of the evaporated fuel processing piping system with the evaporated fuel processing piping system hermetically sealed. Then, the methods of diagnosing the leak in the evaporated fuel processing piping system are classified by an engine negative pressure method, an air pump method, an EONV (Engine Off Natural Vacuum) method, and so on based on differences in the pressure applying method.

In the engine negative pressure method, the pressure in the evaporated fuel processing piping system is reduced by an engine negative pressure, whereupon a canister vent solenoid valve is closed in order to cut off communication between a canister and an atmosphere side, and subsequent pressure variations are monitored. Further, in the EONV method, the canister vent solenoid valve is closed in order to cut off communication between the canister and the atmosphere side, and pressure variations occurring in the evaporated fuel processing piping system due to natural heat dissipation are monitored by using engine exhaust heat.

When the engine negative pressure method and the EONV method are employed, the canister vent solenoid valve is connected to the canister via piping (see Patent Document 1, for example). Alternatively, the canister vent solenoid valve may be inserted into the canister to be integrated therewith.

With these methods, however, engine driving is premised, and therefore the methods are not suited to a hybrid vehicle such that the engine is stopped during travel in order to improve the fuel efficiency.

On the other hand, in the air pump method in which the engine driving is not premised, the canister vent solenoid valve is closed in order to cut off communication between the canister and the atmosphere side, whereupon a pressure is applied to the inside of the evaporated fuel processing piping system by using an air pump, and subsequent pressure variations is monitored.

When the air pump method is employed, a module formed by integrating the canister vent solenoid valve and the air pump may be inserted into the canister.

### CITATION LIST

### Patent Document

Patent Document 1: Japanese Patent Application Laid-Open No. 2007-205231

### SUMMARY OF THE INVENTION

### Problems to be Solved by the Invention

The module formed by integrating the canister vent solenoid valve and the air pump to be used in diagnosing the leak in the evaporated fuel processing piping system, as described above, has a larger overall size than a case having the canister vent solenoid valve and the air pump provided separately, and therefore, when the module is inserted into the canister, a position in which the module can be inserted is limited by a positional relationship between the module and a structure on the exterior of the canister. Accordingly, it is difficult to insert the module into the canister in a position where the combined overall size of the module and the canister does not increase, and as a result, it is difficult to install the system for diagnosing the leak in the evaporated fuel processing piping system in a saved space.

Further, when the air pump is connected additionally in order to perform the diagnosis by the air pump method using the canister into which the canister vent solenoid valve is inserted integrally, the air pump is connected to the canister via piping, but in this case, a nipple for connecting the piping to the canister must be provided on the canister. When the nipple is provided on the canister, a position in which the nipple can be disposed is limited. It is therefore difficult to dispose the nipple in a position where the combined overall size of the nipple and the canister does not increase, and as a result, it is difficult to install the system for diagnosing the leak in the evaporated fuel processing piping system in a saved space.

Furthermore, the canister is manufactured in accordance with the corresponding method such as the engine negative pressure method, the air pump method, the EONV method, and so on, and therefore, when the employed method is changed, it is required to change the canister for one corresponding to that method. Then, when the canister is changed, a great cost including a modification cost of a mold for the canister, a change cost in the piping adapted to the change of the canister, and so on is required.

The present invention has been made to solve the problems described above, and an object thereof is to make it possible to install the system for diagnosing the leak in the evaporated fuel processing piping system in a saved space. Another object is to make it possible to change the employed leak diagnosis method without changing the canister.

### Means for Solving the Problems

An insertion structure according to the present invention includes a canister vent solenoid valve inserted into a first insertion port of a canister having a first chamber that stores evaporated fuel and communicates with an engine side and a fuel tank side and a second chamber that communicates with an atmosphere side and the first chamber, the first insertion port being provided in the second chamber, to maintain and cut off communication between the atmosphere side and the first chamber, and an air pump inserted into a second insertion port provided in the second chamber of the canister to pressurize or depressurize the first chamber.

Further, a canister according to the present invention includes a first chamber that stores evaporated fuel and communicates with an engine side and a fuel tank side, and a second chamber that communicates with an atmosphere side and the first chamber, and includes a first insertion port into which a canister vent solenoid valve is inserted and a second insertion port into which an air pump that pressurizes or depressurizes the first chamber is inserted.

Furthermore, a canister vent solenoid valve according to the present invention includes a main flow path inserted into an insertion port of a canister having a chamber that stores evaporated fuel and communicates with an engine side and a fuel tank side, the insertion port communicating with the chamber, to maintain and cut off communication between the atmosphere side and the chamber, a bypass flow path that connects the atmosphere side to the chamber while bypassing the main flow path, and a first nipple formed on the bypass flow path, and connected to an air pump that pressurizes or depressurizes the chamber.

### EFFECT OF THE INVENTION

According to the present invention, the canister vent solenoid valve and the air pump can be inserted separately into the canister, and therefore a system for diagnosing a leak in an evaporated fuel processing piping system can be installed in a saved space. Moreover, a configuration corresponding to the employed leak diagnosis method can be achieved without changing the canister.

Further, according to the invention, the canister includes insertion ports into which the canister vent solenoid valve and the air pump can be inserted separately, and therefore the system for diagnosing the leak in the evaporated fuel processing piping system can be installed in a saved space. Moreover, the configuration corresponding to the employed leak diagnosis method can be achieved without changing the canister.

Furthermore, according to the invention, the nipple can be provided in the canister vent solenoid valve instead of the canister, and therefore the system for diagnosing the leak in the evaporated fuel processing piping system can be installed in a saved space. Moreover, the configuration corresponding to the employed leak diagnosis method can be achieved without changing the canister.

### BRIEF DESCRIPTION OF THE DRAWINGS

FIG. 1 is a view showing a configuration of an evaporated fuel processing system configured with a canister vent solenoid valve and an air pump insertion structure of a canister according to Embodiment 1 of the present invention;

FIG. 2 is a sectional view of the canister vent solenoid valve according to Embodiment 1 of the invention;

FIG. 3 is a sectional view of the air pump according to Embodiment 1 of the invention;

FIG. 4 is an external view of the canister according to Embodiment 1 of the invention;

FIG. 5 is a sectional view taken when the canister vent solenoid valve and the air pump are inserted with the canister vent solenoid valve and the air pump insertion structure of the canister according to Embodiment 1 of the invention;

FIG. 6 is an external view of the canister according to Embodiment 1 of the invention;

FIG. 7 is a side view and a sectional view taken when the canister vent solenoid valve and the air pump are inserted with the canister vent solenoid valve and the air pump insertion structure of the canister according to Embodiment 1 of the invention;

FIG. 8 is a side view and a sectional view taken when the canister vent solenoid valve and the air pump are inserted with the canister vent solenoid valve and the air pump insertion structure of the canister according to Embodiment 1 of the invention;

FIG. 9 is a sectional view showing a modified use of the canister vent solenoid valve and the air pump insertion structure of the canister according to Embodiment 1 of the invention;

FIG. 10 is an external view of a canister according to Embodiment 2 of the invention;

FIG. 11 is a view showing a partial configuration of an evaporated fuel processing system according to Embodiment 2 of the invention; and

FIG. 12 is a view showing a partial configuration of a modified example of the evaporated fuel processing system according to Embodiment 2 of the invention.

### BEST MODE FOR CARRYING OUT THE INVENTION

Hereinafter, for illustrating the present invention in more detail, embodiments for carrying out the invention will be described according to the accompanying drawings. Identical or corresponding parts of the drawings are denoted by identical reference symbols, and a content already described with another drawing will be omitted where appropriate.

### Embodiment 1

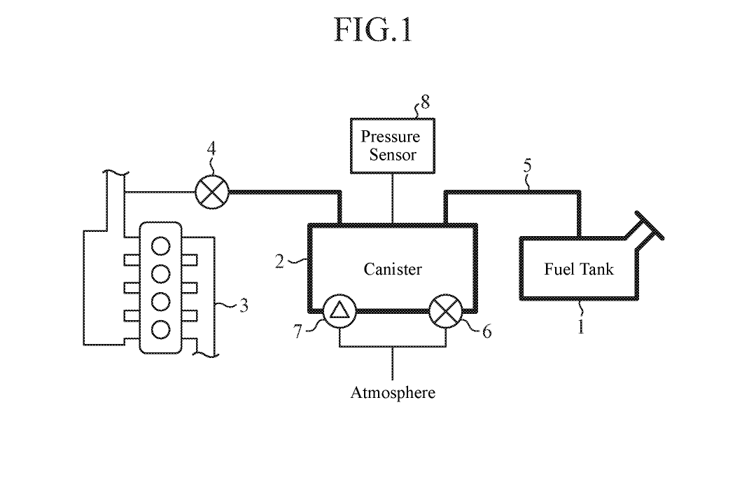

An evaporated fuel processing system shown in FIG. 1 is constituted by a fuel tank 1, a canister 2 that adsorbs and temporarily stores evaporated fuel generated in the fuel tank 1, an intake manifold 3 that introduces the evaporated fuel collected by the canister 2 to an engine, and a purge solenoid valve 4 that controls the amount of evaporated fuel. An evaporated fuel processing piping system 5 indicated by a bold line in FIG. 1 is a piping system on which a leak diagnosis is performed. The leak diagnosis is performed on the evaporated fuel processing piping system 5 by a leak diagnosis system including a canister vent solenoid valve 6 that is inserted into the canister 2 to open and shut off the canister 2 to and from an atmosphere side, an air pump 7 that is likewise inserted into the canister 2 to introduce the atmosphere into the canister 2 from the atmosphere side so that the interior of the evaporated fuel processing piping system 5 is pressurized, and a pressure sensor 8 that detects an internal pressure of the evaporated fuel processing piping system 5.

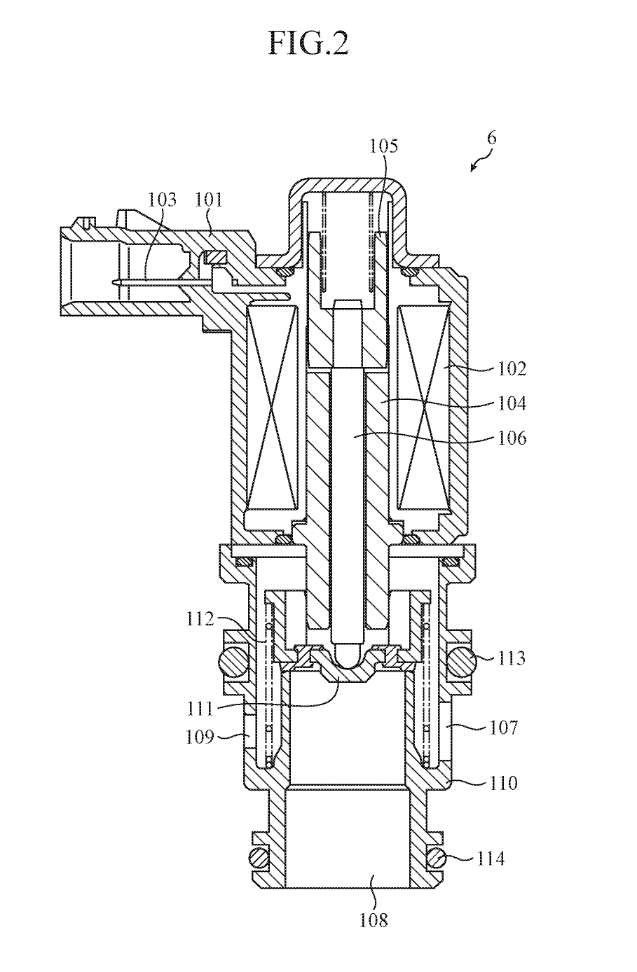

FIG. 2 is a sectional view showing an example of the canister vent solenoid valve 6.

The canister vent solenoid valve 6 is constituted by: a housing 101; a coil 102 wound within the housing 101; a core 104 that is excited when the coil 102 is biased via a terminal 103; a plunger 105 that is capable of reciprocating in accordance with a magnetic attraction force of the core 104; a rod 106 that is supported within the core 104 to move in conjunction with the plunger 105; a valve seat 110 having an opening portion 107 that communicates with the atmosphere side, an opening portion 108 that communicates with the interior side of a canister 2, and an opening portion 109 that likewise communicates with the interior side of the canister 2; a valve body 111 fixed to a tip end of the rod 106; a spring 112 that always biases the valve body 111 in a direction for securing communication between the opening portions 107, 108 of the valve seat 110; and so on.

O-rings 113, 114 that seal gaps between the valve seat 110 and the canister 2 side are disposed on an outer peripheral surface of the valve seat 110.

In the excitation, the valve body 111 moves against a biasing force of the spring 112 to block communication between the opening portions 107, 108 of the valve seat 110. FIG. 2 shows a condition in which the coil 102 is energized so that communication between the opening portions 107, 108 of the valve seat 110 is blocked, in other words, the canister vent solenoid valve 6 is closed.

Note that even when the valve is closed, the opening portions 107, 109 continue communicating with each other via a space in which the spring 112 is disposed.

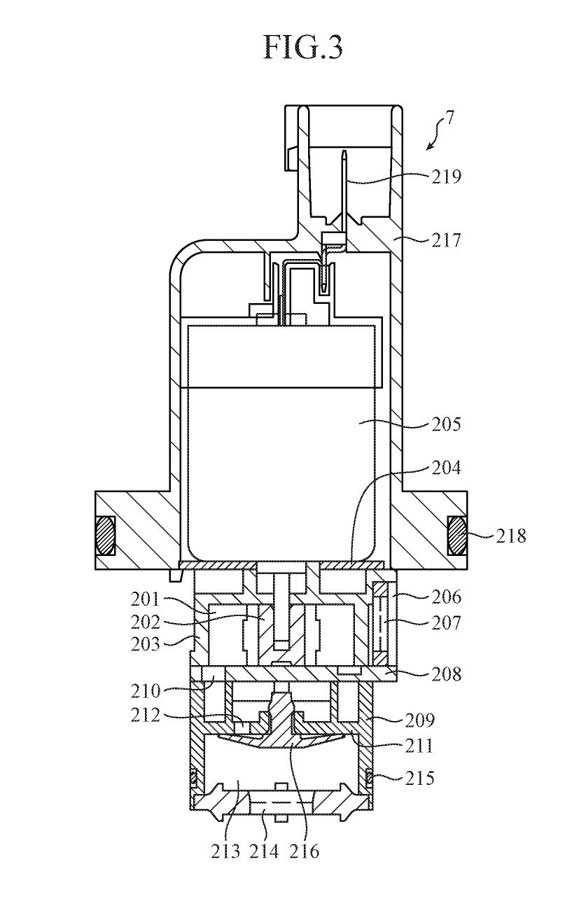

FIG. 3 is a sectional view showing an example of the air pump 7.

The air pump 7 includes a rotor 202 that rotates a plurality of vanes 201, a first housing 203 that is made of resin and houses the vanes 201 and the rotor 202, and a motor 205 that is fixed to the first housing 203 via a metal plate 204 sandwiched therebetween to rotationally drive the rotor 202. Further, an intake port 206 that takes in the atmosphere from the atmosphere side is opened in the first housing 203, and a first filter 207 is attached to the intake port 206.

A bottom surface side of the first housing 203 is closed by a resin plate 208, and a second housing 209 that is a resin-made cylindrical component is further attached to the resin plate 208. The resin plate 208 and the second housing 209 are fastened to the metal plate 204 together with the first housing 203 with screws not shown in the drawing.

A fluid inlet 210 is opened in the resin plate 208, and a fluid outlet 212 is opened in a partition wall 211 of the second housing 209. Further, an outer side of the partition wall 211 serves as an exhaust port 213 that communicates with the canister 2, and a second filter 214 is attached to the exhaust port 213. Furthermore, an O-ring 215 is disposed on an outer peripheral surface of the second housing 209 in order to seal a gap between the second housing 209 and the canister 2 side.

A shaft end portion of a check valve 216 penetrates the partition wall 211 of the second housing 209 to be latched thereto. Further, an umbrella-shaped valve body of the check valve 216 is positioned within the exhaust port 213 to close the outlet 212 when pressure is applied thereto from the canister 2 side.

A cover 217 is provided around the motor 205, and the cover 217 is fixed to the metal plate 204. An O-ring 218 is disposed on an outer peripheral surface of the cover 217 to seal a gap between the cover 217 and the canister 2 side. The motor 205 is energized via a terminal 219.

In the present invention, the canister vent solenoid valve 6 and air pump 7 thus constructed are inserted into the canister 2 separately.

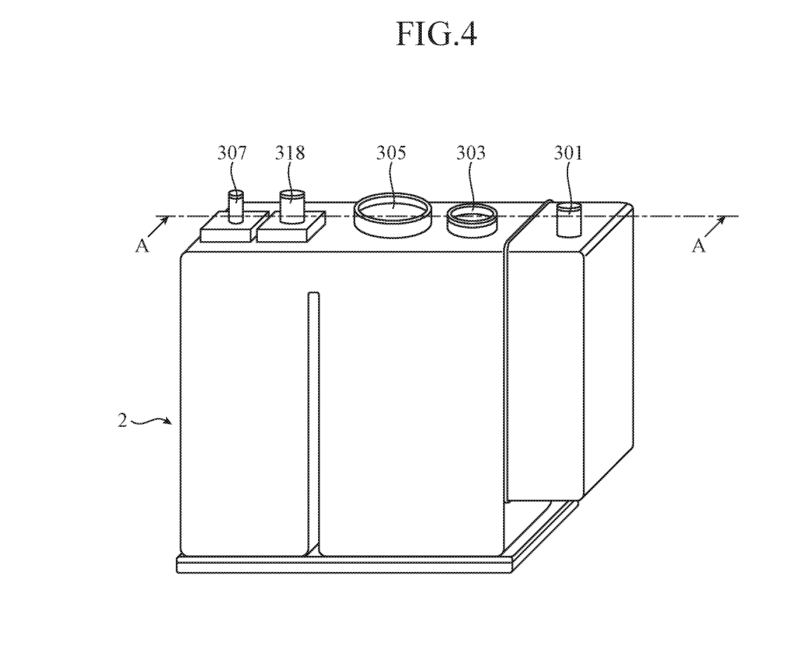

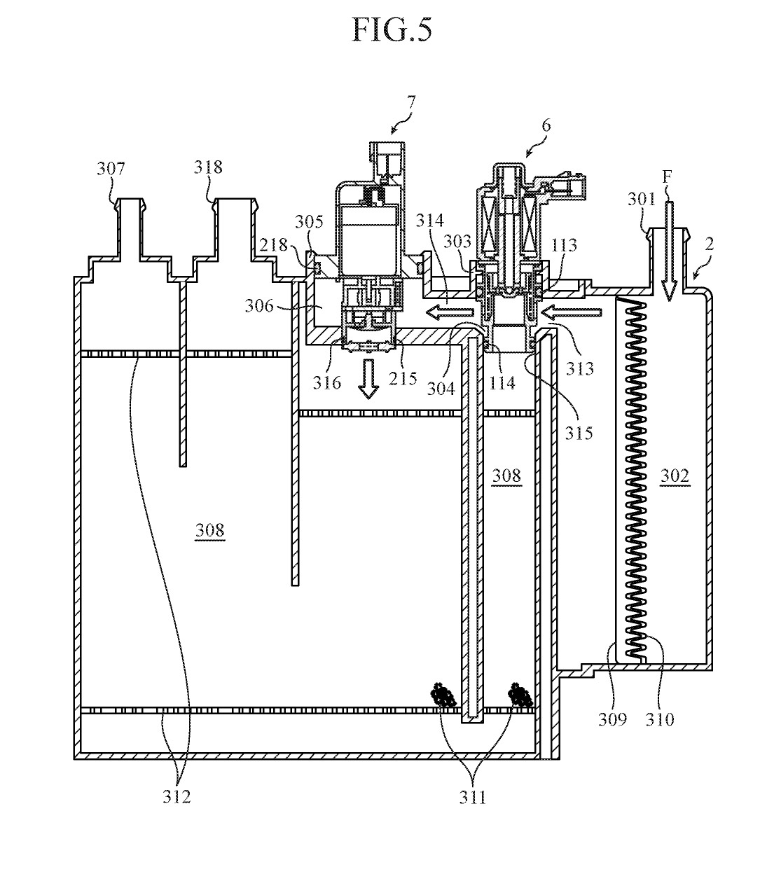

FIG. 4 is an external view of the canister 2 in which the canister vent solenoid valve 6 and the air pump 7 are inserted such that respective axes thereof are parallel to each other. FIG. 5 is a sectional view taken along a line A-A when the canister vent solenoid valve 6 and the air pump 7 are inserted into the canister 2 as shown in FIG. 4. Note that the respective axes of the canister vent solenoid valve 6 and the air pump 7 do not have to be strictly parallel to each other, and may be substantially parallel to each other.

The canister 2 includes a filter chamber 302 formed with an atmosphere port 301 to which piping that communicates with the atmosphere is connected, a second chamber 304 formed with an insertion port 303 for inserting the canister vent solenoid valve 6 thereinto, a third chamber 306 formed with an insertion port 305 for inserting the air pump 7 thereinto, and a first chamber 308 formed with a purge port 307 to which piping that communicates with the purge solenoid valve 4 is connected and an evaporated fuel port 318 to which piping that communicates with the fuel tank 1 is connected.

A filter 310 is supported within the filter chamber 302 by a support material 309.

An adsorbent (activated carbon or the like) 311 that adsorbs evaporated fuel introduced from the fuel tank 1 through the evaporated fuel port 318 is sealed into the first chamber 308, and the interior of the first chamber 308 is partitioned appropriately by a filter 312 so that the adsorbent 311 does not flow out of the first chamber 308.

The filter chamber 302 and the second chamber 304 communicate via a connecting portion 313, while the second chamber 304 and the third chamber 306 communicate via a connecting portion 314. Further, the second chamber 304 and the first chamber 308 communicate via an opening portion 315 that faces the insertion port 303, while the third chamber 306 and the first chamber 308 communicate via an opening portion 316 that faces the insertion port 305.

The canister vent solenoid valve 6 is inserted into the insertion port 303 such that the O-ring 113 of the canister vent solenoid valve 6 is tightly fitted to an inner peripheral surface of the insertion port 303, thereby sealing a gap therebetween. Further, at this time, the O-ring 114 of the canister vent solenoid valve 6 is tightly fitted to an inner peripheral surface of the opening portion 315, thereby sealing a gap therebetween.

When the canister vent solenoid valve 6 is opened, the first chamber 308 is connected to the connecting portion 313 via the canister vent solenoid valve 6 such that the atmosphere air passing through the atmosphere port 301, the filter 310, and the connecting portion 313 can be introduced into the first chamber 308 through the opening portion 315 via the canister vent solenoid valve 6.

Needless to mention, when the canister vent solenoid valve 6 is closed, no atmosphere passing through the connecting portion 313 flows into the first chamber 308 through the opening portion 315 via the canister vent solenoid valve 6. As noted above, however, even when the valve is closed, the opening portions 107, 109 communicate with each other via the space in which the spring 112 is disposed, and therefore the atmosphere passing through the connecting portion 313 is led out to the connecting portion 314 via the canister vent solenoid valve 6.

The air pump 7 is inserted into the insertion port 305 such that the O-ring 218 of the air pump 7 is tightly fitted to an inner peripheral surface of the insertion port 305, thereby sealing the gap therebetween. Further, at this time, the O-ring 215 of the air pump 7 is tightly fitted to an inner peripheral surface of the opening portion 316, thereby sealing the gap therebetween.

When operative, the air pump 7 sends out the atmosphere, that passes through the atmosphere port 301, the filter 310, and the connecting portion 313 to be led out to the connecting portion 314 via the canister vent solenoid valve 6, to the first chamber 308. When the pump is stopped, the atmosphere in the exhaust port 213 of the air pump 7 (in the first chamber 308) is prevented from flowing back to the third chamber 306 side by an action of the check valve 216.

When a leak is diagnosed in the evaporated fuel processing piping system 5, the canister vent solenoid valve 6 is closed to block a flow path between the opening portions 107, 108 by which the evaporated fuel processing piping system 5 is connected to the atmosphere side. Further, the purge solenoid valve 4 is closed to block a flow path by which the evaporated fuel processing piping system 5 is connected to an engine side. As a result, the evaporated fuel processing piping system 5 is hermetically sealed.

In this condition, the air pump 7 is operated to pressurize the interior of the evaporated fuel processing piping system 5. When the internal pressure of the evaporated fuel processing piping system 5 falls to or below a predetermined threshold while the pressurized condition is maintained after stopping the air pump 7, it is diagnosed that a leak occurs. Note that a flow of the atmosphere in which the pressurization is carried out by the air pump 7 during the leak diagnosis is denoted in the drawing as an atmospheric passage F.

When the canister vent solenoid valve 6 and the air pump 7 are inserted into the canister 2 separately in this manner, a choice of positions in which the insertion ports 303, 305 can be disposed is widened in comparison with a case in which an insertion port is provided to insert an integrated module of the canister vent solenoid valve and the air pump into the canister, as in the prior art. Therefore, the insertion ports 303, 305 can be provided in positions where the combined overall size of the canister vent solenoid valve 6, the air pump 7 and the canister 2 does not increase, and as a result, the system for diagnosing the leak in the evaporated fuel processing piping system 5 can be installed in a saved space.

Further, the insertion ports 303, 305 are formed such that the canister vent solenoid valve 6 and the air pump 7 are in parallel with each other in the insertion directions, to be thus insertable into the canister 2 with the respective axes thereof being in parallel with each other. Because the canister 2 is manufactured with a mold, such insertion ports 303, 305 are adapted, so that after the manufacture of the canister 2, it can be easily extracted from the mold.

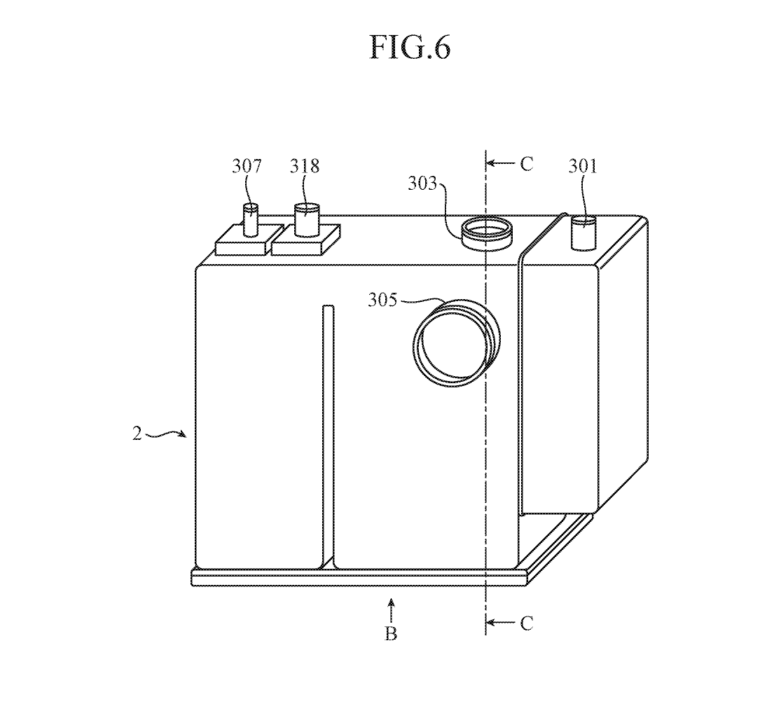

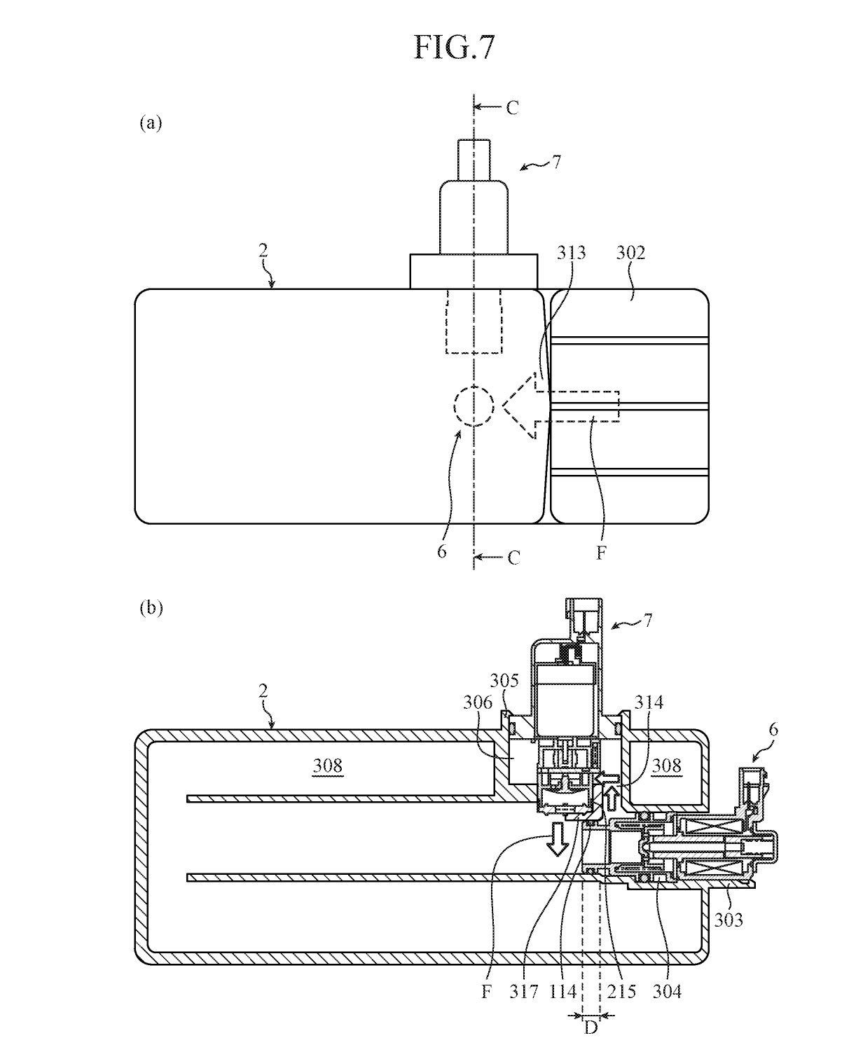

FIG. 6 is an external view of the canister 2 in a case where the canister vent solenoid valve 6 and the air pump 7 are inserted therein such that the respective axes thereof are perpendicular to each other. FIG. 7(a) is a side view showing the canister 2 of FIG. 6 from a B direction with the canister vent solenoid valve 6 and the air pump 7 inserted therein, and FIG. 7(b) is a sectional view taken along a line C-C shown in FIGS. 6 and 7(a). Note that the respective axes of the canister vent solenoid valve 6 and the air pump 7 do not have to be strictly perpendicular to each other, and may be substantially perpendicular to each other.

A latch portion 317 is provided in the interior of the canister 2. The latch portion 317 functions as a stopper when the air pump 7 is inserted thereinto, and holds the inserted air pump 7. Further, the O-ring 114 of the canister vent solenoid valve 6 and the O-ring 215 of the air pump 7 are tightly fitted to the latch portion 317.

When the canister vent solenoid valve 6 and the air pump 7 are inserted thereinto such that the respective axes thereof are perpendicular to each other, as shown in FIGS. 6 and 7, a leak diagnosis is performed on the evaporated fuel processing piping system 5 using a similar flow to that described above.

More specifically, the canister vent solenoid valve 6 is closed to prevent the atmosphere that enters the filter chamber 302 through the atmosphere port 301 and then passes through the connecting portion 313 from flowing directly into the first chamber 308 via the canister vent solenoid valve 6. Further, the purge solenoid valve 4 is closed to prevent the atmosphere in the first chamber 308, which has been pressurized by the air pump 7, from leaking to the engine side. As a result, the evaporated fuel processing piping system 5 is hermetically sealed.

As noted above, however, the opening portions 107, 109 of the canister vent solenoid valve 6 communicate with each other via the space in which the spring 112 is disposed, and therefore the atmosphere passing through the connecting portion 313 is led out to the connecting portion 314 via the canister vent solenoid valve 6.

The air pump 7 sends out the atmosphere led out to the connecting portion 314 via the canister vent solenoid valve 6 to the first chamber 308.

When the canister vent solenoid valve 6 and the air pump 7 are inserted into the canister 2 separately in this manner, the choice of positions in which the insertion ports 303, 305 can be disposed is widened in comparison with a case in which an insertion port is provided to insert an integrated module of the canister vent solenoid valve and the air pump into the canister, as in the prior art. Therefore, the insertion ports 303, 305 can be provided in positions where the combined overall size of the canister vent solenoid valve 6, the air pump 7 and the canister 2 does not increase, and as a result, the system for diagnosing the leak in the evaporated fuel processing piping system 5 can be installed in a saved space.

Further, the insertion ports 303, 305 are formed such that the canister vent solenoid valve 6 and the air pump 7 are perpendicular to each other in the insertion directions, to be thus insertable into the canister 2 with the respective axes thereof being perpendicular to each other. Because the canister 2 is manufactured with the mold, such insertion ports 303, 305 are adapted, so that after the manufacture of the canister 2, it can be easily extracted from the mold.

Furthermore, an insertion amount of the canister vent solenoid valve 6 is secured such that a projection plane obtained by projecting the air pump 7 inserted into the insertion hole 305 from the insertion direction thereof intersects an insertion side end portion of the canister vent solenoid valve 6 inserted into the insertion port 303. In FIG. 7(b), for example, the insertion side end portion of the canister vent solenoid valve 6 intersects the projection plane within a range D in the drawing.

When the canister vent solenoid valve 6 is inserted thereinto as deeply as possible in this manner, the portion of the canister vent solenoid valve 6 that projects to the exterior side of the canister 2 can be reduced, and as a result, the system for diagnosing the leak in the evaporated fuel processing piping system 5 can be installed in a further saved space. Note that an insertion amount of the air pump 7 may be secured such that a projection plane obtained by projecting the canister vent solenoid valve 6 inserted into the insertion hole 303 from the insertion direction thereof intersects an insertion side end portion of the air pump 7 inserted into the insertion port 305.

Moreover, when the latch portion 317 is provided, an insertion operation can be performed easily by an appropriate insertion amount, and the appropriate insertion amount can be maintained easily under use.

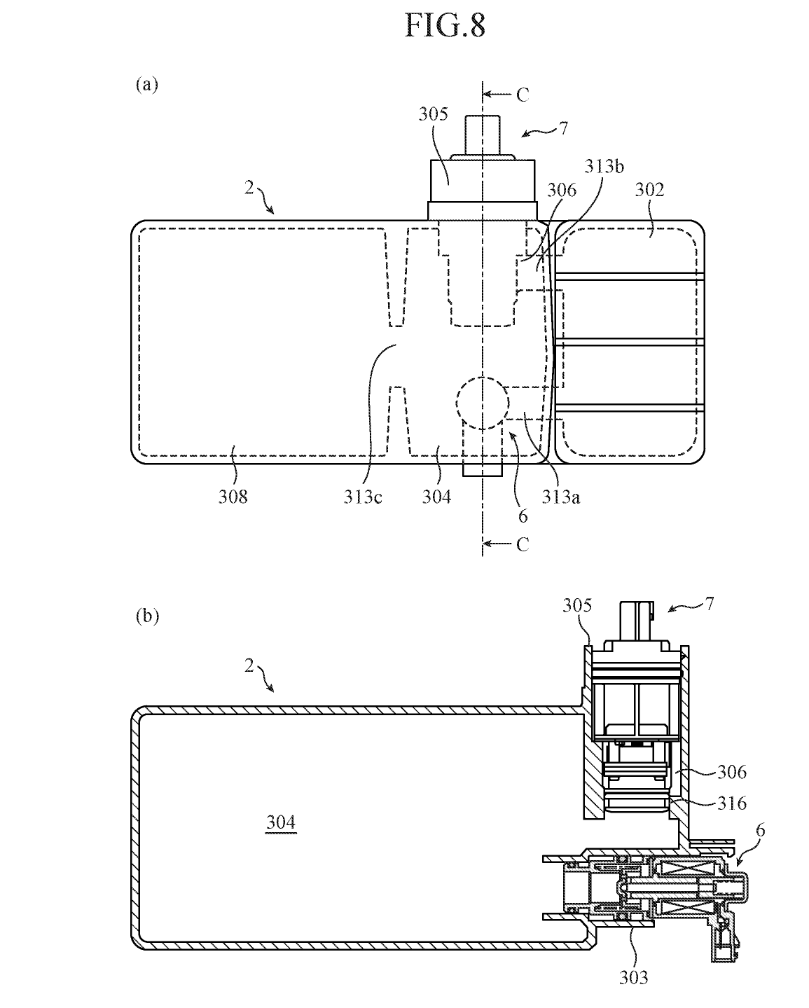

FIG. 8, similarly to FIG. 7, shows the canister vent solenoid valve 6 and the air pump 7 inserted into the canister 2 such that the respective axes thereof are perpendicular to each other. FIG. 8(a) is a side view seen from the B direction in FIG. 6, and FIG. 8(b) is a sectional view taken along the line C-C shown in FIGS. 6 and 8(a). Note that FIG. 8(b) shows a side view of the air pump 7.

In the canister 2 shown in FIG. 8, the filter chamber 302 communicates with the second chamber 304 via a connecting portion 313a, while the filter chamber 302 communicates with the third chamber 306 via a connecting portion 313b. Further, the third chamber 306 communicates with the second chamber 304 via the opening portion 316 that faces the insertion port 305 of the air pump 7, while the second chamber 304 communicates with the first chamber 308 via a connecting portion 313c.

A leak diagnosis performed on the evaporated fuel processing piping system 5 when the canister vent solenoid valve 6 and the air pump 7 are inserted thereinto as shown in FIG. 8 will now be described.

The canister vent solenoid valve 6 is closed to prevent the atmosphere, that enters the filter chamber 302 through the atmosphere port 301 and then passes through the connecting portion 313a, from flowing into the first chamber 308 and the second chamber 304 via the canister vent solenoid valve 6. Note that although the opening portions 107, 109 of the canister vent solenoid valve 6 communicate with each other via the space in which the spring 112 is disposed, the O-rings 113, 114 are tightly fitted to the insertion port 303, and therefore no atmosphere flows into the first chamber 308 and the second chamber 304 through the opening portions 107, 109.

Further, the purge solenoid valve 4 is closed to prevent the atmosphere in the first chamber 308, which has been pressurized by the air pump 7, from leaking to the engine side. As a result, the evaporated fuel processing piping system 5 is hermetically sealed.

In this condition, the air pump 7 sends out the atmosphere passing through the connecting portion 313b to the first chamber 308 and the second chamber 304.

When the canister vent solenoid valve 6 and the air pump 7 are inserted thereinto in the manner shown in FIG. 8, the projection plane obtained by projecting the air pump 7 from the insertion direction thereof intersects a portion further toward the exterior side of the canister 2 than the insertion side end portion of the canister vent solenoid valve 6, and therefore a similar advantageous effect to that obtained when the canister vent solenoid valve 6 and the air pump 7 are inserted thereinto as shown in FIG. 7 is achieved. Furthermore, the structure of the canister 2 is simplified by exclusion of the latch portion 317, and therefore there is also an advantageous effect such that the canister 2 can be manufactured more easily.

Note that according to the above description, the air pump 7 is operated when the leak diagnosis is performed on the evaporated fuel processing piping system 5, but the air pump 7 may also be operated in order to feed the evaporated fuel stored in the canister 2 forcibly to the intake manifold 3 side.

Conventionally, the evaporated fuel stored in the canister 2 is fed to the intake manifold 3 side using negative pressure of the engine. In recent years, however, the number of vehicles such as a hybrid vehicle of which the engine is stopped during travel in order to improve the fuel efficiency has increased, which makes it difficult to use the negative pressure of the engine.

Hence, when the air pump 7 is operated during travel to pressurize the interior of the first chamber 308, the evaporated fuel stored in the canister 2 can be fed to the intake manifold 3 side without the negative pressure of the engine.

Furthermore, in the above description, the operation when the pressurization is made in the leak diagnosis by the air pump 7 is represented, but instead, the leak diagnosis may be performed with depressurization by the air pump 7. In this case, a check valve provided in a vertically opposite orientation to the check valve 216 shown in FIG. 3 is used. Moreover, in this case, the direction of the atmospheric passage F during the leak diagnosis is reversed from that shown in FIGS. 5 and 7.

In the above description, the leak diagnosis is performed using the air pump method, but the EONV method may be used instead. In the EONV method, the canister vent solenoid valve 6 is closed in order to cut off the canister 2 from the atmosphere side, whereupon pressure variation due to natural heat dissipation can be monitored using engine exhaust heat. Accordingly, the air pump 7 can be omitted. Note that in this case, it is necessary to prevent gas from flowing through the insertion port 305.

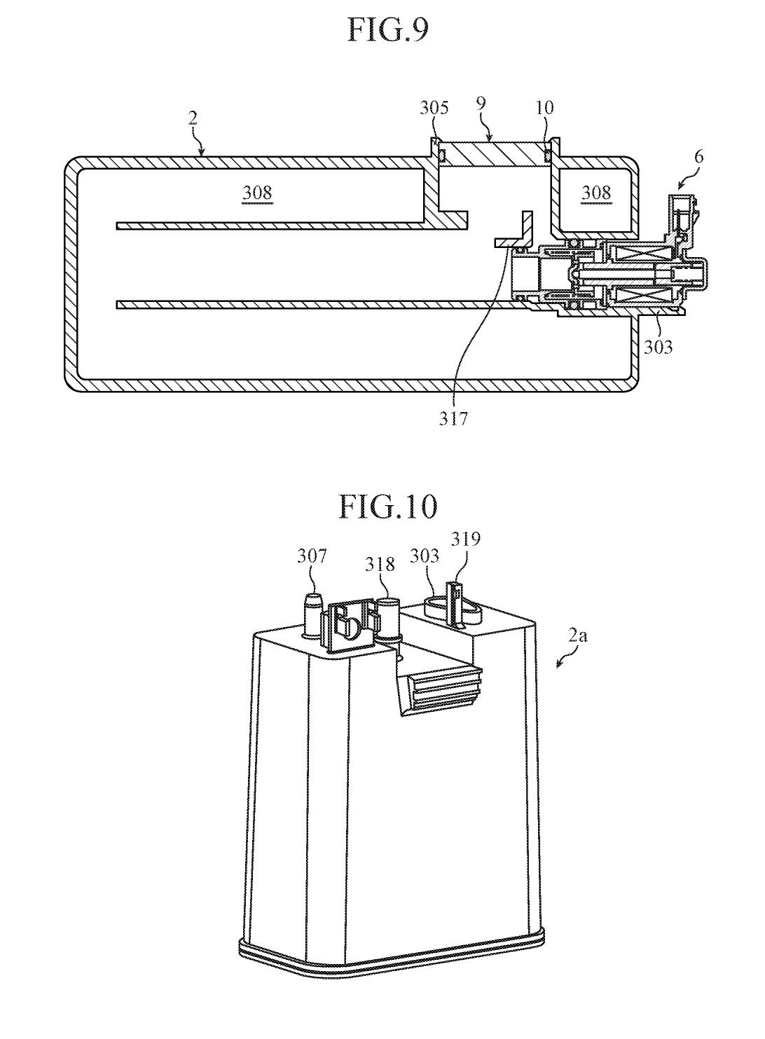

FIG. 9 shows the one in which the insertion port 305 into which the air pump 7 is inserted in FIG. 7 is closed by a lid 9. An O-ring 10 is provided on the lid 9 and fitted tightly to the inner peripheral surface of the insertion port 305 to seal the gap therebetween. In other words, by only disposing the lid 9, the canister 2 applied to the air pump method can be applied to the EONV method.

Needless to mention, even when the leak diagnosis is performed using the EONV method, the air pump 7 may be provided to feed the evaporated fuel stored in the canister 2 forcibly to the intake manifold 3 side.

Thus, the canister 2 can be applied to both the air pump method and the EONV method.

According to Embodiment 1 of the present invention, as described above, when the canister vent solenoid valve 6 and the air pump 7 are inserted into the canister 2 separately, the choice of positions in which the insertion ports 303, 305 can be disposed is widened in comparison with a case in which an insertion port is provided to insert an integrated module of the canister vent solenoid valve and the air pump into the canister, as in the prior art. Therefore, the insertion ports 303, 305 can be provided in positions where the combined overall size of the canister vent solenoid valve 6, the air pump 7 and the canister 2 does not increase, and as a result, the system for diagnosing the leak in the evaporated fuel processing piping system 5 can be installed in a saved space.

Further, when the lid 9 is only inserted into the insertion port 305 in place of the air pump 7 to close the insertion port 305, the canister 2 applied to the air pump method can be applied to the EONV method. In other words, the common canister 2 can be used irrespective of the method.

Furthermore, the insertion direction of the canister vent solenoid valve 6 and the insertion direction of the air pump 7 are perpendicular to each other, and therefore after the manufacture of the canister 2, it can be easily extracted from the mold.

Moreover, when it is configured that one of the canister vent solenoid valve 6 inserted into the insertion port 303 and the air pump 7 inserted into the insertion port 305 intersects the projection plane obtained by projecting the other in the insertion direction thereof, the portions of the canister vent solenoid valve 6 and the air pump 7 that project to the exterior side of the canister 2 can be reduced, and as a result, the system for diagnosing the leak in the evaporated fuel processing piping system 5 can be installed in a further saved space.

Further, the insertion direction of the canister vent solenoid valve 6 and the insertion direction of the air pump 7 are parallel to each other, and therefore after the manufacture of the canister 2, it can be easily extracted from the mold.

Furthermore, the air pump 7 is capable of pressurizing the first chamber 308 to feed the stored evaporated fuel to the engine side, and therefore the evaporated fuel stored in the canister 2 can be fed to the intake manifold 3 side without the negative pressure of the engine.

Note that for the sake of easy-to-understand description, the second chamber 304 and the third chamber 306 are described as separate chambers in the first embodiment, but the second chamber 304 and the third chamber 306 constitute a second chamber in the claims.

### Embodiment 2

FIG. 10 is an external view of a canister 2a. The canister 2a corresponds to one removing the filter chamber 302 and the third chamber 306 from the canister 2, and is equivalent to a conventional canister-vent-solenoid-valve integrated canister corresponding to the engine negative pressure method and the EONV method. The first chamber 308, which is formed with the purge port 307 to which piping that communicates with the purge solenoid valve 4 is connected and the evaporated fuel port 318 to which piping that communicates with the fuel tank 1 is connected, communicates with the second chamber 304, which is formed with the insertion port 303 for inserting the canister vent solenoid valve 6, in the interior of the canister 2a.

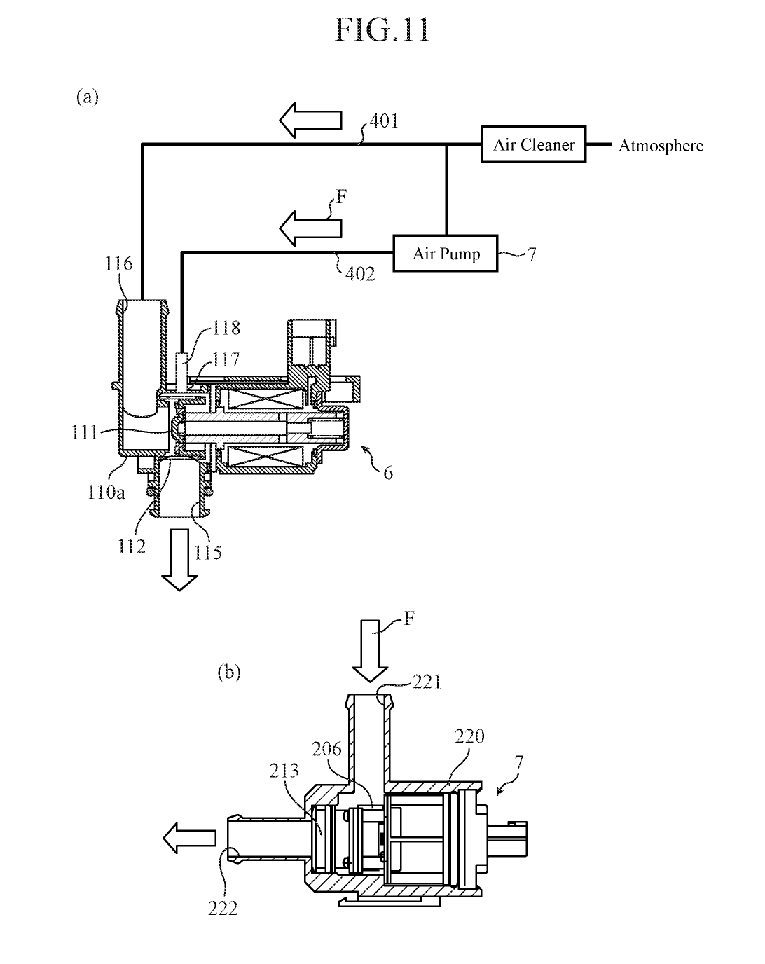

FIG. 11(a) shows a configuration extending from the atmosphere side to the canister 2a. An air cleaner is interposed in piping 401 that communicates with the atmosphere side, and piping 402 bifurcates downstream of the air cleaner. FIG. 11(b) is a partial sectional view showing the air pump 7 when extracted from FIG. 11(a). The canister vent solenoid valve 6 includes a valve seat 110a having opening portions 115 to 117. The opening portion 115, which projects from the space in which the spring 112 is disposed, is inserted into the insertion port 303 of the canister 2a and fixed by a snap-fit 319. The opening portion 117 communicates with the opening portion 115 via the space in which the spring 112 is disposed, and a nipple 118 is provided therein. The opening portion 116 opens or closes the opening portions 115, 117 in accordance with operations of the valve body 111. A flow path extending from the opening portion 116 to the opening portion 115 serves as a main flow path, and a flow path that extends from the opening portion 117 to the opening portion 115 while bypassing the main flow path serves as a bypass flow path.

The opening portion 116 communicates with the atmosphere side via the piping 401. Further, the nipple 118 communicates with the atmosphere side via the piping 402, and the air pump 7 is provided midway in the piping 402.

The air pump 7 includes a cover 220 on an outer side thereof, and the cover 220 includes an opening portion 221 connected to the piping 402 that communicates with the atmosphere side, and an opening portion 222 connected to the piping 402 that communicates with the nipple 118 side.

The opening portion 221 communicates with the intake port 206, and the opening portion 222 communicates with the exhaust port 213.

A leak diagnosis performed on the evaporated fuel processing piping system 5 in a case where the canister 2a, the canister vent solenoid valve 6, the air pump 7, and the pieces of piping 401, 402 are assembled in the above manner will now be described.

When the canister vent solenoid valve 6 is closed, the main flow path is blocked, whereby the atmosphere that passes through the piping 401 and is taken in through the opening portion 116 is prevented from escaping to the opening portion 115. Further, when the purge solenoid valve 4 is closed, the atmosphere in the first chamber 308, which has been pressurized by the air pump 7, is prevented from leaking to the engine side. As a result, the evaporated fuel processing piping system 5 is hermetically sealed.

In this condition, the air pump 7 sends out the atmosphere, introduced through the piping 402 and the opening portion 221 to the opening portion 222, to the opening portion 222 and then to the piping 402 via the intake port 206 and the exhaust port 213. The other end of the side of the piping 402 connected to the opening portion 222 is connected to the nipple 118, and therefore the atmosphere sent out from the air pump 7 escapes to the opening portion 115 through the opening portion 117 provided with the nipple 118 via the space in which the spring 112 is disposed. This atmosphere sent out by the air pump 7 enters the canister 2a through the opening portion 115.

In this manner, when the nipple 118 is provided in the canister vent solenoid valve 6, which makes it possible to pressurize the interior of the canister 2a by the air pump 7, the leak diagnosis can be performed in the air pump method without addition of any change on the canister 2a side. When it is intended that the interior of the canister 2a is pressurized by the air pump 7 provided midway in the piping 402 without providing the nipple 118 in the canister vent solenoid valve 6, a separate opening portion must be provided in the canister 2a, and the nipple must be disposed therein. As a result, a modification must be added to the canister 2a. Further, when the nipple is provided in the canister 2a, a position in which the nipple can be disposed is limited, and as a result, there occurs a possibility that the combined overall size of the nipple and the canister 2a increases.

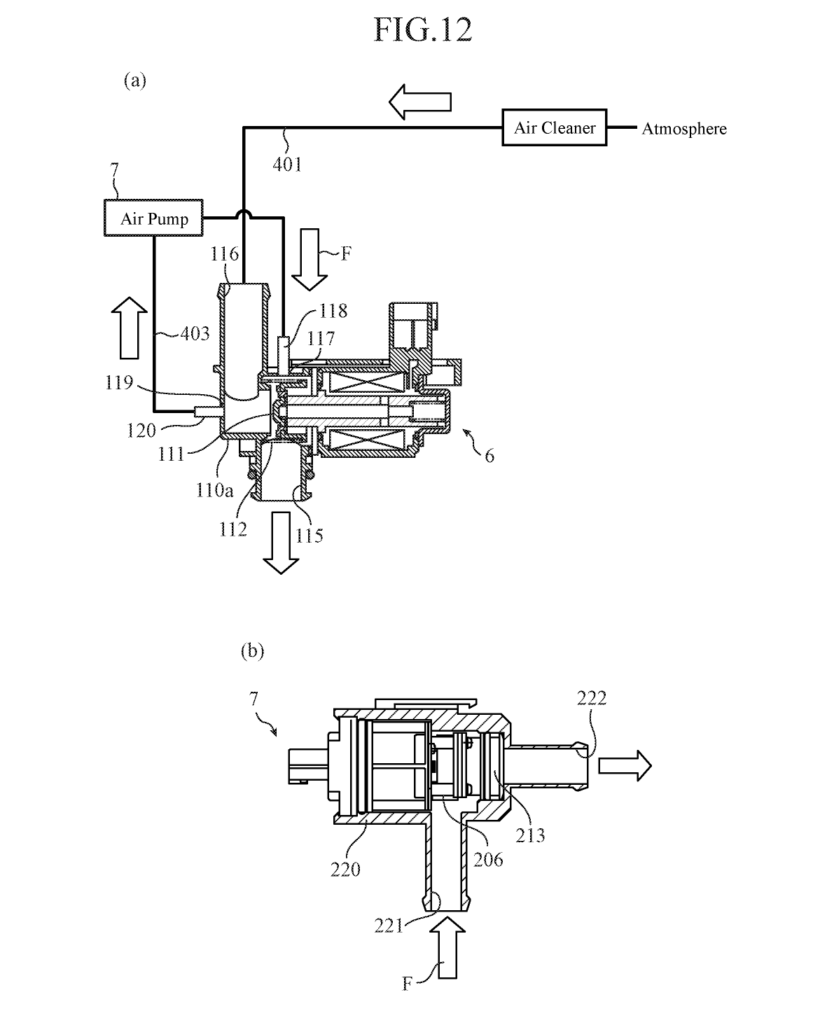

FIG. 12(a) shows a modified example of the configuration extending from the atmosphere side to the canister 2a. FIG. 12(b) is a partial sectional view showing the air pump 7 when extracted from FIG. 12(a).

The canister vent solenoid valve 6 shown in FIG. 12(a) differs from that of FIG. 11(a) in that an opening portion 119 that communicates with the opening portion 116 regardless of whether the canister vent solenoid valve 6 is open or closed is provided in the valve seat 110a on the main path, and that a nipple 120 is provided in the opening portion 119.

Further, respective ends of piping 403 are connected to the nipples 118, 120, and the air pump 7 is provided midway in the piping 403.

All other configurations are identical to those shown in FIG. 11.

The leak diagnosis performed on the evaporated fuel processing piping system 5 in a case where the canister 2a, the canister vent solenoid valve 6, the air pump 7, and the pieces of piping 401, 403 is assembled in the above manner will now be described.

When the canister vent solenoid valve 6 is closed, the atmosphere that passes through the piping 401 and is taken in through the opening portion 116 is prevented from escaping to the opening portion 115. Further, when the purge solenoid valve 4 is closed, the atmosphere in the first chamber 308, which has been pressurized by the air pump 7, is prevented from leaking to the engine side. As a result, the evaporated fuel processing piping system 5 is hermetically sealed.

In this condition, the air pump 7 takes the atmosphere, that enters the opening portion 116 through the piping 401, into the intake port 206 via the opening portion 119 provided with the nipple 120, the piping 403, and the opening portion 221, and sends out this atmosphere to the opening portion 222 and then to the piping 403 via the exhaust port 213. The other end of the side of the piping 403 connected to the opening portion 222 is connected to the nipple 118, and therefore the atmosphere sent out to the piping 403 escapes to the opening portion 115 through the opening portion 117 provided with the nipple 118 via the space in which the spring 112 is disposed. Thus, the atmosphere sent out by the air pump 7 enters the canister 2a through the opening portion 115.

In this manner, when the nipple 120 is provided in the canister vent solenoid valve 6 in addition to the nipple 118, which makes it possible to pressurize the interior of the canister 2a by the air pump 7 which is provided midway in the piping 403 that connects the nipples 118, 120, the piping 401 and piping 403 can be provided as completely independent piping. Therefore, in contrast to the configuration shown in FIG. 11, the piping 402 that bifurcates from the piping 401 is not required, and as a result, the piping structure can be simplified.

According to Embodiment 2 of the present invention, as described above, the configuration for performing the leak diagnosis can be realized by providing the nipple 118 in the opening portion 117 of the bypass flow path, and therefore the nipple 118 does not have to be provided in the canister 2a. As a result, the system for diagnosing the leak in the evaporated fuel processing piping system 5 can be installed in a saved space.

Further, there is provided with the nipple 120 formed in the main flow path, and the nipple 118 is connected to the nipple 120 via the air pump 7, so that communication with the atmosphere side is achieved via the main flow path, the nipples 118, 120 do not have to be provided in the canister 2a. As a result, the system for diagnosing the leak in the evaporated fuel processing piping system 5 can be installed in a saved space, and the piping structure can be simplified.

Furthermore, there is no need to add a configuration for connecting the air pump 7 to the canister 2a, and therefore the conventional canister-vent-solenoid-valve integrated canister 2a corresponding to the engine negative pressure method and the EONV method can be appropriated as the canister 2a for the air pump method.

Note that the embodiments may be combined freely within the scope of the present invention. Further, any of the constituent elements of the embodiments may be modified or omitted within the scope of the present invention.

### INDUSTRIAL APPLICABILITY

As described above, with the insertion structure, canister, and canister vent solenoid valve according to the present invention, the system for diagnosing the leak in the evaporated fuel processing piping system can be installed in a saved space, and therefore the insertion structure, canister, and canister vent solenoid valve are suitable for use in a vehicle or the like having a small engine room.

### DESCRIPTION OF REFERENCE NUMERALS and SIGNS

1 fuel tank
2, 2a canister
3 intake manifold
4 purge solenoid valve
5 evaporated fuel processing piping system
6 canister vent solenoid valve
7 air pump
8 pressure sensor
9 lid
10 O-ring
101 housing
102 coil
103 terminal
104 core
105 plunger
106 rod
107 to 109 opening portion
110, 110a valve seat
111 valve body
112 spring
113, 114 O-ring
115 to 117 opening portion
118 nipple
119 opening portion
120 nipple
201 vanes
202 rotor
203 first housing
204 metal plate
205 motor
206 intake port
207 first filter
208 resin plate
209 second housing
210 inlet
211 partition wall
212 outlet
213 exhaust port
214 second filter
215 O-ring
216 check valve
217 cover
218 O-ring
219 terminal
220 cover
221, 222 opening portion
301 atmosphere port
302 filter chamber
303 insertion port
304 second chamber
305 insertion port
306 third chamber
307 purge port
308 first chamber
309 support material
310 filter
311 adsorbent
312 filter
313, 313a to 313c, 314 connecting portion
315, 316 opening portion
317 latch portion
318 evaporated fuel port
319 snap-fit
401 to 403 piping

1-9. (canceled)

10. A canister having an insertion structure comprising:
a canister vent solenoid valve inserted into a first insertion port of a canister having a first chamber that stores evaporated fuel and communicates with an engine side and a fuel tank side and a second chamber that communicates with an atmosphere side and the first chamber, the first insertion port being provided in the second chamber, to maintain and cut off communication between the atmosphere side and the first chamber; and
an air pump inserted into a second insertion port provided in the second chamber of the canister to pressurize or depressurize the first chamber,
wherein an insertion direction of the canister vent solenoid valve and an insertion direction of the air pump are perpendicular to each other.

11. The canister having the insertion structure according to claim 10, wherein a projection plane obtained by projecting one of the canister vent solenoid valve inserted into the first insertion port and the air pump inserted into the second insertion port from the corresponding insertion direction intersects the other thereof.

12. The canister having the insertion structure according to claim 10, comprising a lid that is inserted into the second insertion port in place of the air pump to close the second insertion port.

13. The canister having the insertion structure according to claim 10, wherein the air pump pressurizes the first chamber to feed the stored evaporated fuel to the engine side.

14. A canister vent solenoid valve comprising:
a main flow path inserted into an insertion port of a canister having a chamber that stores evaporated fuel and communicates with an engine side and a fuel tank side, the insertion port communicating with the chamber, to maintain and cut off communication between the atmosphere side and the chamber;
a bypass flow path that communicates the atmosphere side and the chamber while bypassing the main flow path; and
a first nipple formed in the bypass flow path, and connected to an air pump that pressurizes or depressurizes the chamber.

15. The canister vent solenoid valve according to claim 14, comprising a second nipple formed in the main flow path,
wherein the first nipple is connected to the second nipple via the air pump to communicate with the atmosphere side through the main flow path.
